(19) United States
(12) Patent Application Publication
(10) Pub. No.: US 2009/0283062 A1
(43) Pub. Date: Nov. 19, 2009

(54) Actuator with self-locking helical gears for a continuously variable valve lift system

(76) Inventor: Elias Taye, Macomb Twp., MI (US)

Correspondence Address: DELPHI TECHNOLOGIES, INC., M/C 480-410-202, PO BOX 5052, TROY, MI, 48007, US

(21) Appl. No.: 12/152,337

(22) Filed: May 14, 2008

(51) Int. Cl. F01L 1/34; F16H 1/04; F16H 1/08

(52) U.S. Cl. 123/90.15; 74/421 R; 74/424.5

(57) ABSTRACT

A CVVL system including a self-locking helical gear pair with, optionally, a transmission to increase output torque of the actuator. The self-locking helical gear pair provides high forward efficiency and a fully mechanically self-locking feature. The actuator therefore requires a smaller motor to perform the same actuation as a prior art worm-gear system. The CVVL system comprises two helical gears having a radial pressure angle \acute{α} between 45° and 75° and a helix angle β between 60° and 80°. An asymmetric tooth profile is presently preferred, reducing contact stress and permitting higher torque density. Preferably, the helical gears are discontinuous and comprise laminated spur gear slices and hence are less costly to produce than continuous helical gears. Configurations are possible within the scope of the present invention include a single stage gear system; a multiple stage gear system; a planetary gear system; and an internal or external gear system.

### TECHNICAL FIELD

The present invention relates to variable valve lift systems for combustion valvetrains of internal combustion engines; more particularly, to such systems wherein the valve may be lifted to any height in a continuous range of heights, defined herein as “continuously variable valve lift” (CVVL); and most particularly, to such a system having a high-efficiency actuator employing a self-locking helical gear arrangement.

### BACKGROUND OF THE INVENTION

It is well known in the internal combustion engine arts to provide an engine with means for varying the lift of one or more combustion valves to improve engine efficiency and/or decrease emissions under certain engine operating conditions. Some known systems vary valve lift between two steps, for example, fully open (activated) and non-opening (deactivated); such systems can be thought of as switchable systems. Other systems, especially in the compression-ignited engine arts, benefit from mechanisms which are capable of lifting a valve to any desired height within a continuous range of heights; such systems may be thought of as continuously variable.

An important consideration in variable valve lift systems is the mechanical rigidity of the valvetrain during a partial lift event. When the variable lift is actuated directly by an electric solenoid or a hydraulic system that may contain air bubbles, torque fluctuations imposed on a camshaft by the sequential and overlapping opening and closing of valves can cause variation in the desired lift and hence in the intended gas flow profile.

To overcome these shortcomings, it is known in the art of CVVL systems to provide a mechanically self-locking actuation system employing a worm gear actuator. See, for example, U.S. Pat. No. 7,174,887 to Shuichi Ezaki. An inherent drawback of worm gear actuators is very low mechanical efficiency; that is, because of the high sliding velocity due to a small worm lead angle, a high percentage of the actuator torque, typically more than 50%, is consumed in friction with the pinion gear. Further, the mechanical self-locking feature becomes practical only at relatively high gear ratios, on the order of 80:1 and higher. For gear ratios lower than about 80:1, the backdrive efficiency remains low but the system is not completely self-locking. Because of the low mechanical efficiency, the actuator requires a relatively large and expensive motor to drive the worm gear.

What is needed in the art is a self-locking continuously variable drive system for variable valve lift that provides higher forward efficiency, a smaller and less expensive motor, and is fully mechanically self-locking.

It is a principal object of the present invention to improve the self-locking capability of a drive mechanism for a CVVL system.

It is a further object of the present invention to increase the efficiency of the self-locking actuator of a CVVL system.

It is a further object of the invention to reduce the size and cost of a CVVL system.

### SUMMARY OF THE INVENTION

Briefly described, a CVVL system in accordance with the present invention includes a self-locking helical gear pair with, optionally, an additional gear system to increase output torque of the actuator. The self-locking helical gear pair provides higher forward efficiency, being at least twice that of a conventional worm gear actuator, and a fully mechanically self-locking feature. The actuator therefore requires a smaller motor to perform the same actuation as a prior art worm-gear system, which reduces the cost and volume of the CVVL system. Thus, a CVVL system in accordance with the present invention is significantly less bulky and costly than a comparable prior art system and is fully mechanically self-locking over the entire range of action.

The CVVL system includes a self-locking gear pair comprising two helical gears that have a high radial pressure angle, between about 45° and about 75°, and a high helix angle, between about 60° and about 80°. These gears require high addendum modification (positive and negative profile shift) such that the pitchpoint is beyond the active portion of the contact line, which creates a mechanically self-locking condition against backdrive. Tooth profiles may be symmetric, although an asymmetric profile is presently preferred to reduce contact stress and permit higher torque density. Preferably, the helical gears are discontinuous and comprise a plurality of spur gear slices which can produce smoother power transmission and lower transverse contact ratio. Such discontinuous helical gears are significantly less costly to manufacture.

Various configurations are possible within the scope of the present invention, including but not limited to a single stage gear system; a multiple stage gear system; a planetary gear system; and an internal or external gear system.

The principle of self-locking helical gears is disclosed in a Russian engineering paper from 1969 (“Self-locking in gear mechanism”, by T. G. Ishakov; T R. Kazanskova Aviation Institute of A. H. Typoleva, 1969 Ed. 105, pp 3-15 (in Russian)). However, this principle has not been applied previously to an automotive CVVL system such as is the subject of the present invention. Further, the use of asymmetric gear profiles in self-locking helical gears as disclosed herein is also novel.

### BRIEF DESCRIPTION OF THE DRAWINGS

The present invention will now be described, by way of example, with reference to the accompanying drawings, in which:

FIG. 1 is an elevational cross-sectional view of a prior art worm-gear driven CVVL system, substantially as disclosed in U.S. Pat. No. 7,174,887 to Shuichi Ezaki, and also showing substitution of a helical gear pair in accordance with the present invention;

FIG. 2 is an isometric view of a driving helical gear and a driven helical gear in accordance with the present invention;

FIG. 3 is a schematic view of a helical gear showing derivation of helical angle β;

FIG. 4 is a schematic cross-sectional view of a driving helical gear and a driven helical gear showing the trigonometric derivation of the self-locking mechanism in accordance with the present invention;

FIG. 5 is an isometric view in partial cutaway showing a discontinuous helical gear formed of a plurality of slices of spur gears;

FIG. 6 is a schematic plan view showing assembly of a discontinuous 5-tooth helical gear from three 5-tooth spur gear slices; and

FIG. 7 is an elevational cross-sectional view showing lamination of a plurality of spur gear slices to form a discontinuous helical gear in accordance with the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DESCRIPTION OF THE PREFERRED EMBODIMENTS

Self-locking helical gears are known in the prior art from relatively few publications that demonstrate the possibility of designing a helical gear pair to be self-locking and provide general guidelines on how to obtain the self-locking feature. Despite these early publications, however, self-locking helical gears have not been widely reduced to practice, especially in automotive applications, such as the present invention. Further, the CVVL system disclosed herein includes improvements that are novel in the art, including: laminated helical gears to reduce fabrication costs; a preferred range of pressure angle and helical angles appropriate for steel gears.

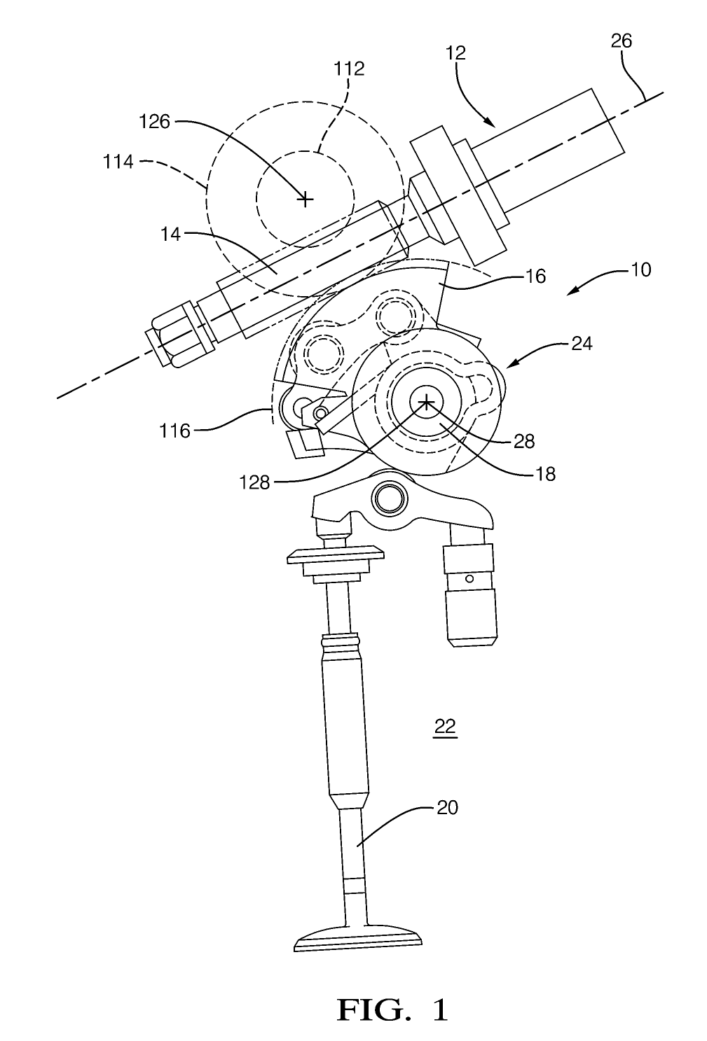

Referring to FIG. 1, in a prior art CVVL system 10, substantially as disclosed in U.S. Pat. No. 7,174,887 to Shuichi Ezaki, which is herein incorporated by reference, a motor actuator 12 causes rotation of a worm 14, causing a worm gear segment 16, also known as a worm wheel, to rotate a control shaft 18 on which the worm wheel is mounted for varying the lift of an engine combustion valve 20 in a manner described in the incorporated reference in response to rotation of an engine cam (not shown) in an internal combustion engine 22. When control shaft 18 rotates clockwise in FIG. 1, the variable valve mechanism 24 decreases the operating angle and lift amount of valve 20.

Prior art CVVL system 10 typifies any CVVL system wherein changing the rotational position of a control shaft causes variation in the operating angle and lift amount of an associated engine valve. The shortcomings of such a prior art CVVL system including a worm gear drive are described above. The present invention overcomes these shortcomings.

Still referring to FIG. 1, in accordance with the present invention, driven worm gear segment 16 is replaced by a driven helical gear segment 116, and worm 14 and actuator 12 are replaced by a helical driving gear 114 driven by a rotary actuator 112 and meshed with helical driven gear segment 116. Note that in the prior art, worm 14 rotates about an axis 26 contained in a plane orthogonal to a plane containing the axis 28 of worm gear segment 16 and control shaft 18; whereas in the present invention, the respective rotation axes 126,128 of helical gears 114,116 are contained in a common plane having parallel axes of rotation. If gears 114,116 were provided as ordinary spur gears having transverse teeth, the improved gearing arrangement shown would not be self-locking; that is, reverse torque of a driven spur gear 116 caused by alternating camshaft torque would cause a reverse torque in the driving spur gear 114, allowing variation to occur in the rotary position of control shaft 18 and hence variation in the lift of valve 20. However, as described in detail below, if the driving and driven gears are provided as specially-formed helical gears, reverse torque of a driven helical gear 116 caused by alternating camshaft torque causes a forward torque in the driving helical gear 114, thereby self-locking the gear pair and preventing variation in the rotary position of driven helical gear 116 and control shaft 18. Such an arrangement is defined herein as being “self-locking” of the driving and driven gears.

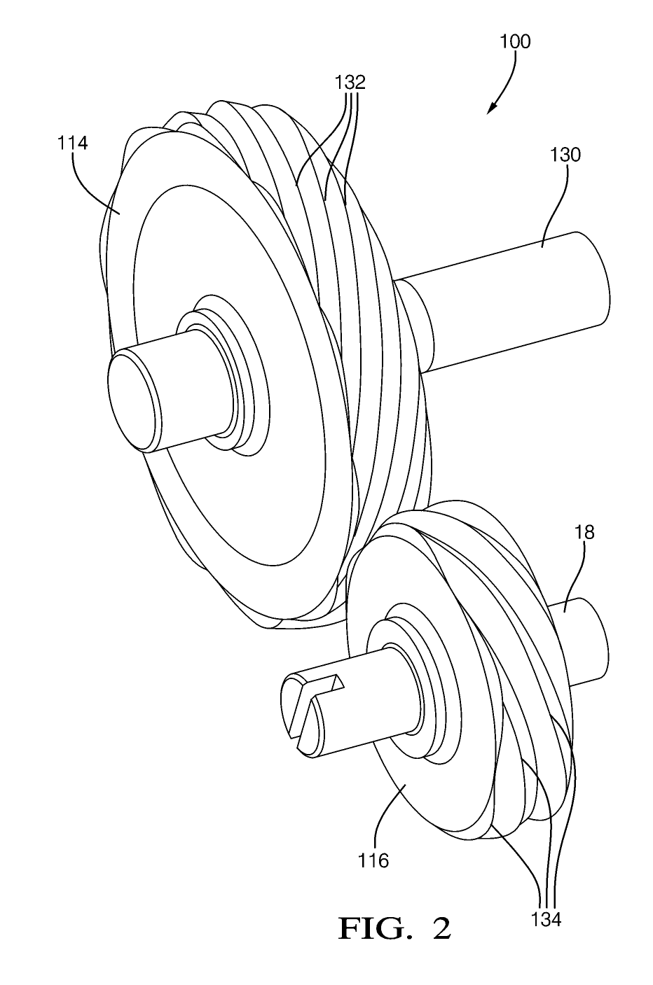

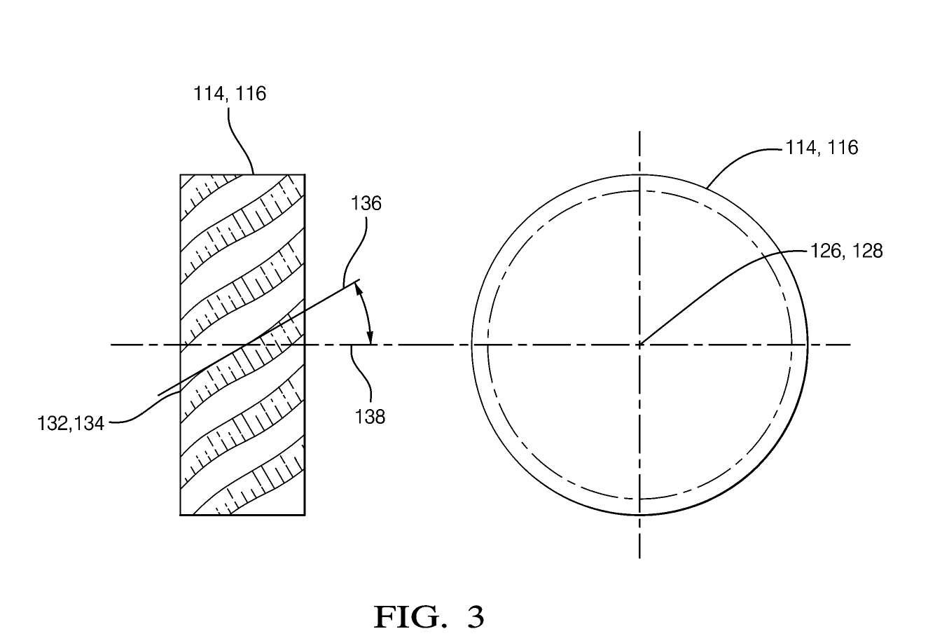

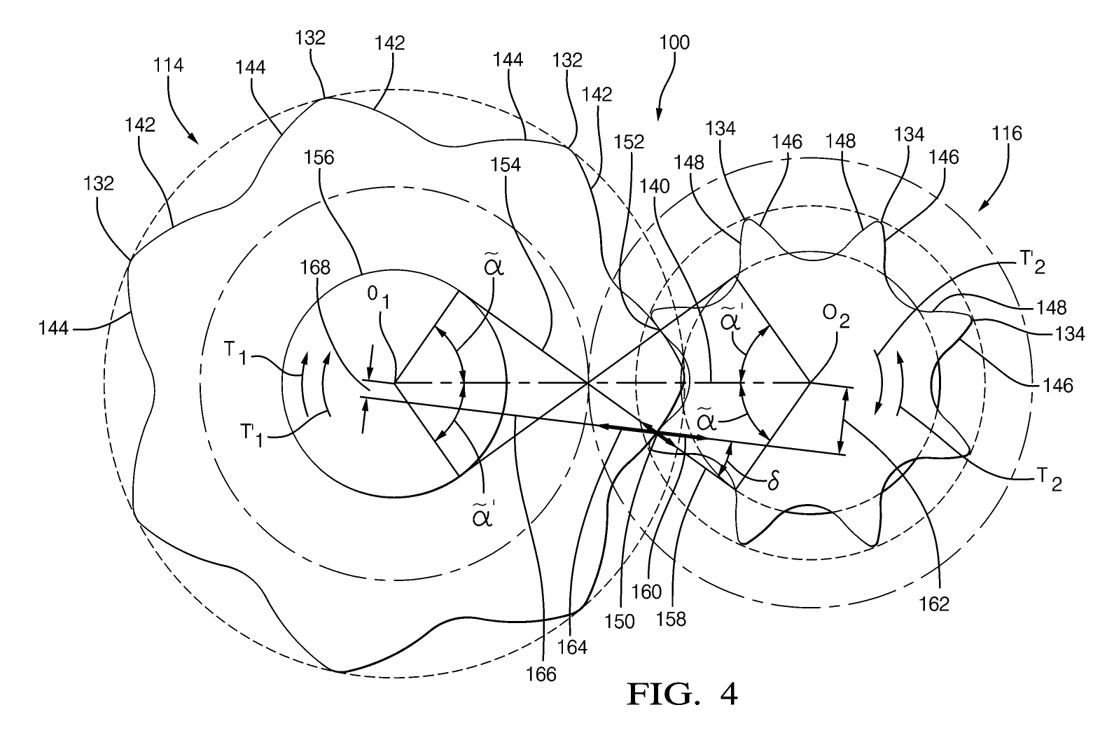

Referring to FIGS. 2 through 4, an exemplary pair 100 of helical gears is shown for purposes of discussion that are representative of gears 114,116 shown in FIG. 1, gear 114 being the driving gear and gear 116 being the driven gear. Gear 114 is mounted to a shaft 130 for being driven by rotary actuator 112 (FIG. 1). Gear 116 is mounted to shaft 18. It will be seen that a conventional geared transmission (not shown) may be interposed conventionally as may be desired between gear 114 and actuator 112 to increase the torque available to driving gear 114 or between gear 116 and control shaft 18 to increase the torque to the control shaft. Gears 114,116 have opposite direction helical teeth 132,134, respectively, which are defined by the helical angle β formed between the tangent 136 to any tooth 132,134 and a plane 138 containing the axis 126,128 of the gear, as shown in FIG. 3. Gears 114,116 in accordance with the present invention are characterized by having helix angles β between 60° and 80° and thus exhibit a relatively low number of teeth in a cross-sectional view taken orthogonal to the gear axes 126,128, as shown in FIGS. 2 and 4.

Helical gearing within the scope of the present invention may be either external or internal. “External” refers to gearing wherein the teeth are on the outside of both gears, and the centers of rotation are on opposite sides of the mesh point. “Internal” refers to gearing wherein the teeth are on the outside of one gear and on the inside of the other gear, as for example in a planetary gear system, and the centers of rotation are on the same side of the mesh point.

Referring now to FIG. 4, the principles behind self-locking helical gears in accordance with the invention will now be discussed.

Helical drive gear 114 having rotational center O₁ includes helical teeth 132. Helical driven gear 116 having rotational center O₂ including helical teeth 134. The teeth of both gears are modified involute teeth. Gears 114,116 are meshed along a center line 140 between O₁ and O₂. Drive gear 114 rotates clockwise, exerting torque T₁. Thus, the leading flanks 142 of teeth 132 are the driving flanks, and trailing flanks 144 are the coast flanks. Conversely, for driven gear 116, the trailing flanks 146 of teeth 134 are the driven flanks, and leading flanks 148 are the coast flanks. The driving and driven teeth meet at a drive point 150, and the coast flanks meet at a corresponding driven point 152. The pressure exerted by driving gear 114 at drive point 150 is orthogonal to the contact tangents, defining a contact force direction 154 within driving gear 114 that in turn defines a driving torque arm 155, at a radial pressure angle \acute{α}, that is the radius of a torque circle 156 for torque T₁. In the absence of friction, contact force direction 154 creates a response force direction 158 in driven gear 116 again normal to the contact tangents. However, sliding friction between the helices turns the response force direction through a friction angle γ such that the effective response force direction is vector 160 from the driven torque arm 162, creating a counterclockwise response forward torque T₂ in driven gear 116.

Considering now the geometry of back-drive in driven gear 116, when gear 116 is urged in a clockwise direction as by a reversal of torque in an associated automotive cam as would pertain in a CVVL system 24 (FIG. 1), a clockwise torque T′₂ is produced in the opposite direction from forward torque T₂. Because of friction angle γ, the force direction produced in driving gear 114 is vector 164 along line 166, which is the direction of effective response force vector 160.

Of special interest is the fact that reverse force line 166 departs extensively from forward force line 154 to the extent that line 166 lies across the rotation center O₁ at response torque arm 168, creating a response torque T′₁ in the same direction as driving torque T₁ and counter to torque T′₂. Thus, back torque T′₂ in gear 116 is effectively opposed by forward torque T′₁ in gear 114, preventing reverse rotation of gear 116. Helical gear system 100 is thus self-locking, in accordance with the present invention.

Important elements of the self-locking feature include the pressure angle α, and the helix angle β. Also of importance are material selection, surface finish selection and appropriate lubrication design to achieve higher gear efficiency. These latter elements lead to values of friction coefficients for the driving and driven wheel. In conventional gear designs, the angle α is typically in the range of about 14.5° to about 25°, and usually about 20°. Similarly, angle β is usually less than 45°. In order to achieve a self-locking condition according to the present invention, however, values of α and β outside these ranges must be considered. With these common upper limits removed, values of α, and β may be found and appropriate material and surface finish may be chosen, that will satisfy this self-locking condition and higher gear efficiency. Specifically, it was found that angles α between 45° and 75°, and angles β between 60° and 80°, are satisfactory. Preferable, the gears are made of steel having a grinded surface finish resulting in a coefficient of friction on the order of between 0.11 and 0.18. Together, angle values within these ranges and material selection to produce the desired coefficient of friction will generally satisfy the necessary self-locking condition according to the present invention.

Referring still to FIG. 4, the drive and coast flank profiles as shown are symmetrical for each tooth. However, it is known in the art of gear manufacture to provide gears wherein the drive and coast flank profiles differ. Such gear teeth are said to be “asymmetric”. In a further aspect of the present invention, gears 114,116 are provided with asymmetric tooth profiles, resulting in different pressure angles for the coast contact point 152 from the driving contact point 150 (in FIG. 4, \acute{α}=\acute{α}′ because the gears are symmetric). Asymmetric gears reduce contact stress, thus resulting in higher torque density. Such optimization can reduce operating noise and vibration. In a CVVL application using asymmetric gears, since self-locking is desirable in both the clockwise and counterclockwise directions of rotation, the values of the differing pressure angles are both between 45° and 75°. Within this range, pressure angles for the asymmetric gears may be optimized based on other design parameters such as gear efficiency, contact ratio, or ease of manufacturing. Thus, a symmetrical profile (angle α equal to angle α′) is a special case. In a presently preferred asymmetric embodiment, the pressure angle \acute{α} is 60° on the drive flank and 50° on the coast flank (drive and coast flank defined for clockwise rotation); helix angle β is 77°; the normal module (tooth-to-tooth distance in a direction normal to the helical angle) is 1.8 mm; center-center distance is 60 mm; and the friction coefficients are 0.118 on the drive flank; and 0.175 on the coast flank, based on the selected materials and lubrication.

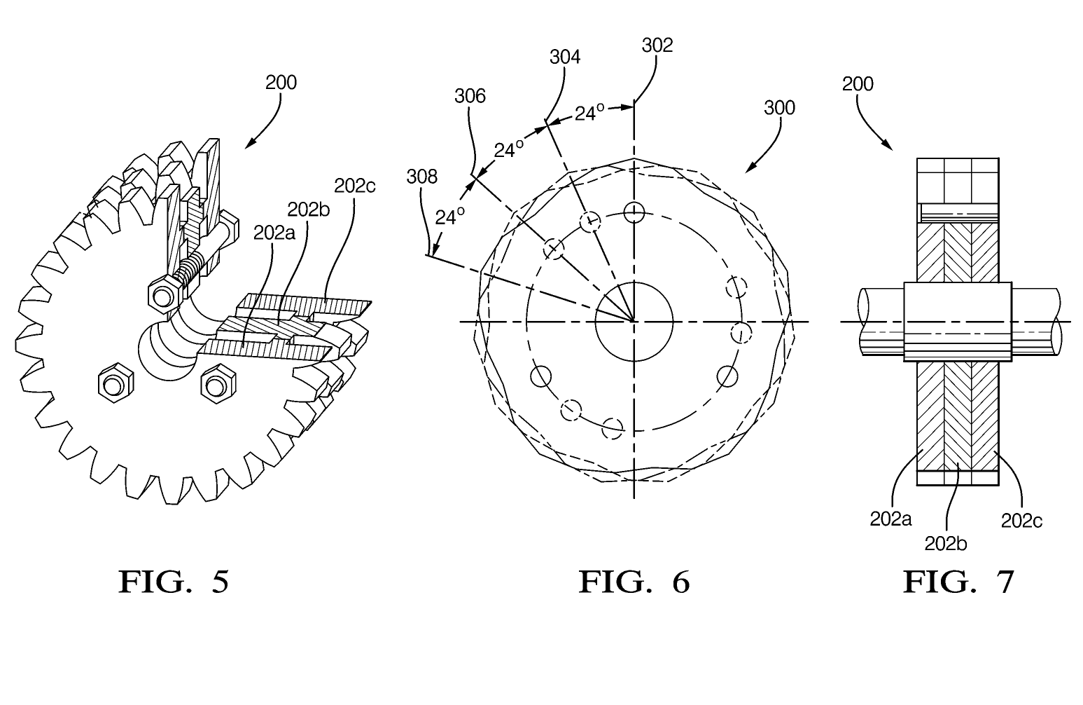

In another aspect of the invention, the helical gears can be formed from designed as discontinuous and comprise laminated spur gear slices, bolted or pinned together, to form a discontinuous tooth profile. Formed in this manner, the gears do not generate axial forces and allows lower transversal contact ratio on the slice for higher tooth strength. Manufacturing costs for helical gears in this form are substantially reduced as compared to cutting the individual gear teeth of a continuous helical gear. The number of slices used to form the laminated helical gear may be from two to as many as practical. More slices provide smoother transmission, creating more nearly continuous helix. Referring to FIGS. 5 through 7, a helical gear formed from spur gear slices, in accordance with the invention, is shown wherein each slice is rotationally offset from the adjacent slice or slices by a fixed rotation angle equal to helix angle β (FIG. 3).

FIG. 5 shows a discontinuous helical gear 200 formed of three 24-tooth spur gear slices 202a,202b,202c, each rotationally offset from the previous slice. The slices are bolted or otherwise fixed together as shown in FIG. 7. Such a discontinuous helical gear functions in the present invention identically to a continuous helical gear such as gears 114,116 shown in FIG. 2.

FIG. 6 shows schematically a 5-tooth 3-slice discontinuous helical gear 300 wherein the second slice 304 is offset rotationally from the first slice 302 by 24°, and the third slice 306 from the second slice 304 by an additional 24°. Generally, the angle 24° is calculated by dividing 360° by the number of teeth (5 in this example) multiplied by the number of spur gear slices (3 in this example). Note that the apparent next 24° rotation represents the next tooth of first slice 302.

While the invention was described specifically for a CVVL mechanism, it should be understood to be applicable to any similar positioning mechanism where self-locking is desirable for internal combustion engine or any other application.

While the invention has been described by reference to various specific embodiments, it should be understood that numerous changes may be made within the spirit and scope of the inventive concepts described. Further, Accordingly, it is intended that the invention not be limited to the described embodiments, but will have full scope defined by the language of the following claims.

What is claimed is:

1. A continuously positioning system comprising first and second meshed helical gears defining respective driving and driven gears for reducing an unwanted positioning variation by reducing back-drive of said system,
wherein said first and second meshed helical gears have a radial pressure angle \acute{α} of between about 45° and about 75° and a helix angle β of between about 60° and about 80° for both gears; and
wherein said positioning system is a continuously variable valve lift system for an internal combustion engine.

2. A system in accordance with claim 1 wherein said helical gears are formed of a plurality of spur gears.

3. A system in accordance with claim 1 wherein said gears are formed of steel.

4. A system in accordance with claim 1 wherein teeth on said gears are asymmetric.

5. A system in accordance with claim 3 wherein said gears have grinded teeth profile whose coefficient of friction for steel is between 0.11 and 0.18.

6. A system in accordance with claim 1 further comprising a rotary actuator for driving said driving gear.

7. A system in accordance with claim 6 further comprising a transmission disposed between said rotary actuator and said driving gear.

8. A system in accordance with claim 1 wherein said continuously variable valve lift mechanism is actuated by an engine camshaft and comprises a control rod upon which said driven gear is disposed.

9. A system in accordance with claim 1,
wherein a driving torque arm and driving pressure direction are present in said driving gear on a first side of a center-to-center line between rotational centers of said driving and driven gears, and
wherein a back-drive driven torque arm and driving pressure direction are present in said driving gear on a second side of said center-to-center line, said driving rotational center being common to both of said driving and driven torque arms.

10. An internal combustion engine, comprising a continuously variable valve lift system including,
first and second meshed helical gears defining respective driving and driven gears for reducing back-drive of said system,
wherein said first and second meshed helical gears have a radial pressure angle \acute{α} of between about 45° and about 75° and a helix angle β of between about 60° and about 80° for both gears.

11. A meshed pair of helical gears comprising a driving gear and a driven gear, wherein said driving and driven gears are provided with asymmetrical teeth, the driving and coast flanks of said teeth having different profiles.
